(19) United States
(12) Patent Application Publication
(10) Pub. No.: US 2015/0000152 A1
(43) Pub. Date: Jan. 1, 2015

(54) CENTRIFUGAL PELLET DRYER SCREEN WITH INTEGRAL OUTWARDLY PROJECTING DEFLECTOR STRIPS

(71) Applicant: Gala Industries, Inc., Eagle Rock, VA (US)

(72) Inventor: David E. BRYAN, Buchanan, VA (US)

(21) Appl. No.: 13/927,674

(22) Filed: Jun. 26, 2013

(51) Int. Cl. F26B 17/18

(52) U.S. Cl. CPC F26B 17/18
USPC 34/58

(57) ABSTRACT

A cylindrical dryer screen having raised embossed regions in the form of embossed deflector strips on the outer surface is provided for a centrifugal pellet dryer. The embossed deflector strips are integral and project outwardly so as not to encroach upon the space within the screen housing for the rotor and rotor blades. The embossed screen with its outwardly projecting deflector strips effectively deflects the pellets back toward the rotor where the pellets are reengaged with rotor energy, resulting in increased dryer efficiency and flow rate.

### BACKGROUND OF THE INVENTION

1. Field of the Invention

The present invention generally relates to a centrifugal pellet dryer of the type which utilizes a bladed lift rotor conveying moisture laden plastic pellets or other solid particles upwardly within a cylindrical screen. The centrifugal force imparted to the particles by rotation of the lift rotor causes the particles to engage the interior surface of the screen, and moisture on the particles is discharged through the screen in a manner well known in the art. More specifically, the present invention relates to a product flow-modifying deflector associated with the internal surface of the cylindrical screen.

2. Description of the Related Art

Centrifugal pellet dryers are well known in the art for separating water or moisture from plastic pellets and other solid particles, such as a slurry of water and plastic pellets produced by underwater pelletizers. Centrifugal pellet dryers of the prior art include a vertically disposed outer housing, a cylindrical screen oriented in the housing and a driven bladed rotor positioned centrally inside the screen. The rotor moves water laden pellets or other solid particles upwardly within the screen with centrifugal forces imparted to the particles by radial air flow from the rotor (see FIG. 1) causing the particles to move radially outwardly into engagement with the screen for discharge of water through the screen. The dried particles are discharged from the upper end of the screen and housing, and water is discharged from the lower end of the housing.

Centrifugal pellet dryers of this type are disclosed in U.S. Pat. Nos. 7,171,762, 7,024,794, 6,807,748, and 6,237,244, commonly owned by the assignee of this application. In the operation of such dryers, the pellets or other particles being moved vertically and radially by the bladed rotor engage the cylindrical screen with substantial velocity and usually bounce off the screen back toward the rotor for imparting further vertical and centrifugal forces to the particles as they are moved upwardly inside the screen. This is depicted by the “good” flow characteristic illustrated in FIG. 2. As further shown in FIG. 3, the “best” flow of both product and air occurs when the radial air flow from the rotor does not just push the pellets but actually flows around them.

However, conventional centrifugal dryers used in the market today all have a common problem relating to the air flow created by the normal rotation of the rotor. The combination of rotor blade geometry and other physical factors creates an air flow that can greatly affect the flow of the product through the dryer as it bounces between the rotor and the screen.

Furthermore, with the advent of newer plastic materials which form softer pellets, or pellets with flat or lentoid geometries, and the making of very small pellets, or so-called micropellets, using underwater pelletizers, difficulties have been encountered in conveying and subsequently drying such pellets in known centrifugal dryers. In addition, known centrifugal dryers have encountered difficulty in conveying and subsequently drying ground flake plastic materials which are formed from recycled soda bottles, milk containers and the like, as well as certain other plastic particles such as ground battery casings.

More specifically, and as depicted by the “poor” flow characteristics in FIG. 2, softer and smaller pellets, pellets with flat or lentoid geometries, and plastic flakes, as well as certain other plastic and similar particles, tend to collect and circulate in the clearance band “X” (see FIG. 2) between the outer edges of the rotor blades and the inner surface of the screen. Rather than bouncing around in the manner of harder and larger pellets or particles, these particles become trapped against the screen by the air flow and/or surface tension created by moisture on the screen. This undesirable circular flow and resultant entrapment of the softer and smaller pellets, pellets with flat or lentoid geometries, and plastic flakes and particles along the inner surface of the screen is sometimes referred to as “banding”. This banding reduces product flow through the rotor area of the dryer and increases power requirements for maintaining rotational speed of the rotor. Further, it has been found that banding also reduces the efficiency of moisture separation from the solid particles, can cause high amperage requirements within the dryer, and reduces overall efficiency of the centrifugal dryer. These problems often result in fines and fiber-like “hair” production (often referred to as angel hair in the industry).

The problem of banding is particularly evident with pellets having a flat or lentoid geometry as the relatively large planar surface area of this shape most naturally causes the pellets to adhere to the inner surface of the screen and, because of the associated low profile of such pellets, makes them difficult to dislodge. As illustrated by the “worst” flow in FIG. 3, the larger the product's surface area in one dimension, or the more flake-like or lentoid the pellets, the greater the opportunity for the outward air flow of the rotor to trap the product against the screen. This phenomenon greatly reduces the necessary bounce required to reengage the product with the outward and upward action of the dryer rotor.

One solution for overcoming this problem of banding is set forth in U.S. Pat. No. 6,739,457 (“the '457 patent”), which is commonly owned by the assignee of this invention. The disclosure of the '457 patent is hereby expressly incorporated herein by reference as if fully set forth in its entirety.

In the ’457 patent, deflector strips are fastened to the inside of the dryer screen using multiple fasteners fitted within countersunk holes machined within the strips. This method of fastening results in the deflector strips being relatively expensive to manufacture and also necessitates that the screen also be provided with dedicated holes which can create undesirable stress concentrations within the screen. In addition, should the fasteners become loosened, either through vibration, aging or other cause, there is the risk that the deflector strips could extend into the moving rotor with resulting damage. Further, any spacing between the deflector strip and the screen may collect portions of the pellets or other foreign matter, particularly with pellets having a flat or lentoid geometry, thus leading to possible contamination in future product runs.

U.S. Pat. No. 8,220,177 (“the '177 patent”), also commonly owned by the assignee of this invention, solved the problems associated with deflector strips that are fastened to the screen. In the '177 patent, the inside of the cylindrical screen is provided with one or more embossed regions, each of which effectively forms an integral deflector protruding from the inside surface of the screen as shown in FIG. 4. As with the fastened-on deflector strips of the '457 patent, the embossed screen disclosed in the '177 patent disrupts the circular flow of the particles to improve particle flow through the rotor area of the dryer by aiding in the rotor's vertical lift of the particles and by eliminating particle banding. Unlike the '457 patent, however, the embossed deflector screen of the '177 patent eliminates the risks of contamination and of a loose deflector strip extending into the moving rotor, while also reducing manufacturing costs. In addition, because the embossed regions are preferably integrated into a non-perforated area of the screen, the embossed regions can actually strengthen the overall screen structure.

Both the bolt-on and integral deflector strips can create a problem in that both types of strips project inwardly and therefore encroach upon the dryer rotor. In other words, the inward projecting strips reduce the necessary spacing, or clearance, between the outer edges of the rotor blades and the inner surface of the screen. Further, while it is often believed that the rotor operates within the screen and center support ring in a perfectly concentric assembly, thus providing equidistant spacing uniformly around the rotor; in many cases this perfect design cannot be achieved in practice.

As a result, there are dryer configurations in which it is undesirable to reduce clearances, even in selective areas, to a potential level of interference and thus create a situation for equipment damage and failure. Further, the centrifugal dryer is not a static device and, as such, the mere operation of the machine can cyclically load certain components, causing movement that can be largely unpredictable from an engineering standpoint.

Therefore, a need exists for a centrifugal pellet dryer screen that prevents banding without reducing clearances between the dryer screen and the rotor.

### SUMMARY OF THE INVENTION

The present invention is used with a centrifugal pellet dryer of the vertical type having a vertical cylindrical screen associated with a vertical housing and a bladed rotor oriented inside the cylindrical screen for conveying a slurry of water and polymer resin particles upwardly in the dryer. Centrifugal forces imparted to the solid particles by the rotor cause the particles to impact the screen to discharge water outwardly through the screen, while dried particles are discharged from an upper end of the dryer and water is discharged from the lower end of the housing in a manner well known in this art. Cylindrical screens for centrifugal pellet dryers are typically made from several screen sections which are vertically aligned and interconnected together.

In order to overcome the problems of such centrifugal dryers when separating water from soft and/or small pellets or plastic flakes, and certain other plastic particles with difficult to convey geometries such as lentoid-shaped pellets, as well as the potential problems associated with the inwardly projecting deflector strips of the '457 and '177 patents, the inside of the cylindrical screen is provided with one or more embossed regions which project outwardly from the otherwise cylindrical screen. The embossed regions are preferably positioned in a generally vertical direction. As with the fastened-on deflector strips of the '457 patent and the integral inwardly protruding strips of the '177 patent, the outwardly projecting embossed regions of the present invention can serve to disrupt the circular flow of the particles, thus aiding in the rotor's vertical lift of the particles and eliminating particle banding, but without impinging on the clearance of the rotor and rotor blades.

The effectiveness of embossed regions that project outwardly is counter-intuitive as it was believed by persons of ordinary skill in the art that only inwardly projecting deflectors had the ability to effectively deflect pellets and prevent banding and other problems associated with separating water from soft and/or small pellets. However, it was surprisingly found that the inside surface of the outwardly projecting embossed region, opposite the direction of flow of the pellets as they flow around the inner circumference of the cylindrical screen, forms a deflection zone or internal deflecting surface as shown in FIG. 8. Thus, as the pellets strike the deflection zone or internal deflecting surface they are deflected inwardly toward the rotor in the same manner as the deflector strips of the '457 and '177 patents.

Further, like the screen of the '177 patent, the integral nature of the outwardly projecting embossed region or regions on the dryer screen of the present invention eliminated the risks of contamination and of a loose deflector strip extending into the moving rotor, while also reducing manufacturing costs. In addition, because the embossed regions are preferably integrated into a non-perforated area of the screen, the embossed regions actually strengthen the overall screen structure.

It is therefore an object of the present invention to provide one or more outwardly projecting embossed regions on the perforated or non-perforated areas of the cylindrical screen of a centrifugal pellet dryer.

Another object of the present invention is to form one or more deflection zones or internal deflecting surfaces in accordance with the preceding object in which the outwardly projecting embossed regions circumferentially spaced around the surface of the screen with the number and size of the embossed regions being varied depending upon the diameter of the screen, with there preferably being one to four embossed regions in most cases.

A further object of the present invention is to integrally form one or more outwardly projecting embossed regions in accordance with the preceding objects which form vertical or acutely angled elongated deflection zones or internal deflecting surfaces on the inner surface of the cylindrical screen of a cylindrical pellet dryer.

A still further of the present invention is to form one or more deflection zones or internal deflecting surfaces in the form of elongated embossed deflector strips which project outwardly of the dryer screen that have smoothly ramped sides formed integrally with the screen which prevent pellets from being caught in the embossed regions or strips and ensure redirection of the pellets back into the rotor where the pellets are reengaged with rotor energy for reenergized circular and upward movement.

Yet another object of the present invention is to provide a centrifugal pellet dryer with a cylindrical screen having outwardly projecting embossed regions in accordance with preceding objects in which the embossed screen provides a retrofitable solution to the known problems of flat and lentoid-shaped products becoming trapped against the screen in a centrifugal pellet dryer.

A further object of the present invention is to provide an embossed deflector screen with outwardly projecting embossed regions in accordance with the preceding objects that allows a centrifugal pellet dryer of a given size to run higher product flow rates which expands the scope of production achievable without obtaining a larger dryer.

A still further object of the present invention is to provide a cylindrical screen of centrifugal pellet dryers with one or more outwardly projecting embossed regions in accordance with the preceding objects, which will conform to conventional forms of manufacture, be of simple construction and easy to use so as to provide a deflector screen that will be economically feasible, long lasting and relatively trouble free in operation.

These together with other objects and advantages which will become subsequently apparent reside in the details of construction and operation as more fully hereinafter described and claimed, reference being had to the accompanying drawings forming a part hereof, wherein like numerals refer to like parts throughout.

### BRIEF DESCRIPTION OF THE DRAWINGS

FIG. 1 generally depicts the radial air flow of a conventional rotor in a centrifugal pellet dryer.

FIG. 2 illustrates the effects of air flow from the rotor of FIG. 1 and the resulting flow characteristics of various different shaped pellets.

FIG. 3 is a further illustration of best and worst air and pellet flow characteristics associated with the various shaped pellets of FIG. 2.

FIG. 4 is a schematic elevational view of a centrifugal pellet dryer illustrating a sectional cylindrical screen and bladed lift rotor assembly associated with a dryer housing.

FIG. 5 is a perspective view of one of the dryer screen sections of FIG. 4, having two deflector strips mounted on the interior surface with fastening elements in accordance with the '457 patent.

FIG. 6 is a schematic partial sectional view of the screen section and one of the conventional deflector strip shown in FIG. 5.

FIG. 7 is a schematic partial sectional view of a dryer screen similar to FIG. 6, but illustrating an inwardly protruding embossed deflector strip as disclosed in the '177 patent.

FIG. 8 is a schematic partial sectional view of a centrifugal pellet dryer screen having an outwardly projecting embossed region in accordance with the present invention.

FIG. 9 is a perspective view of a dryer screen section with two outwardly projecting embossed strips extending vertically and slightly angled, and formed integrally in the non-perforated portions of the screen section in accordance with the present invention.

FIG. 10 is an upper perspective schematic view of an outwardly projecting embossed region like that shown in FIG. 8, showing the relationship between the screen, the deflection zone and the dryer rotor blades.

FIG. 11 is an enlarged view of Detail A of FIG. 10.

FIGS. 12A-12D are schematic illustrations of alternative configurations for the outwardly projecting embossed regions of a centrifugal pellet dryer screen in accordance with the present invention.

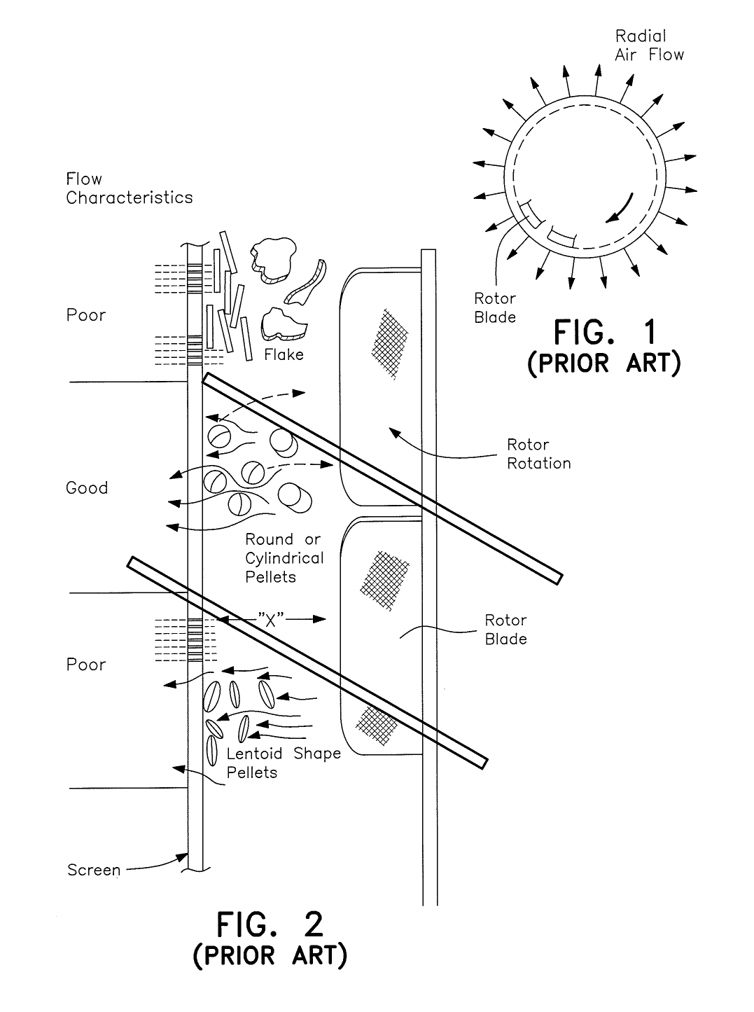

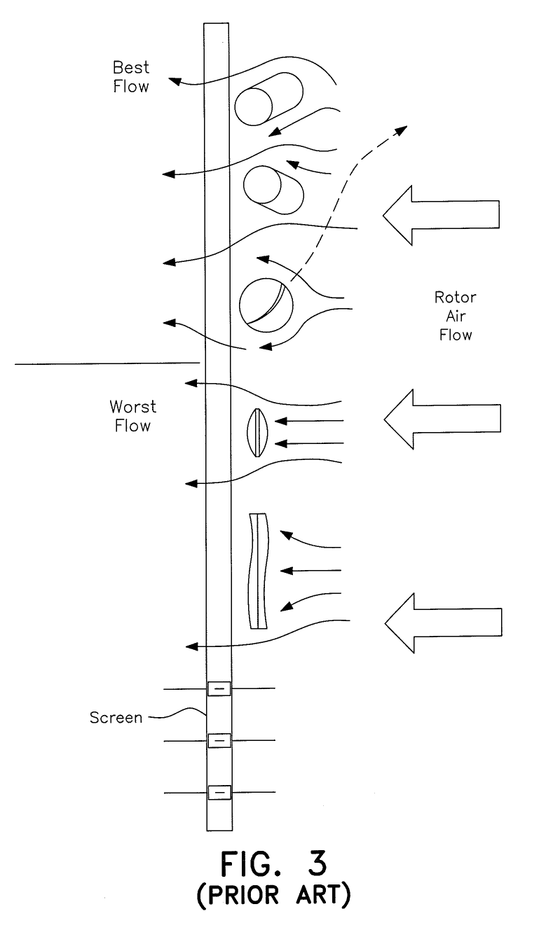

### DETAILED DESCRIPTION OF THE PREFERRED EMBODIMENTS

In describing the preferred embodiment of the invention illustrated in the drawings, specific terminology will be resorted to for the sake of clarity. However, the invention is not intended to be limited to the specific terms so selected, and it is to be understood that each specific term includes all technical equivalents which operate in a similar manner to accomplish a similar purpose.

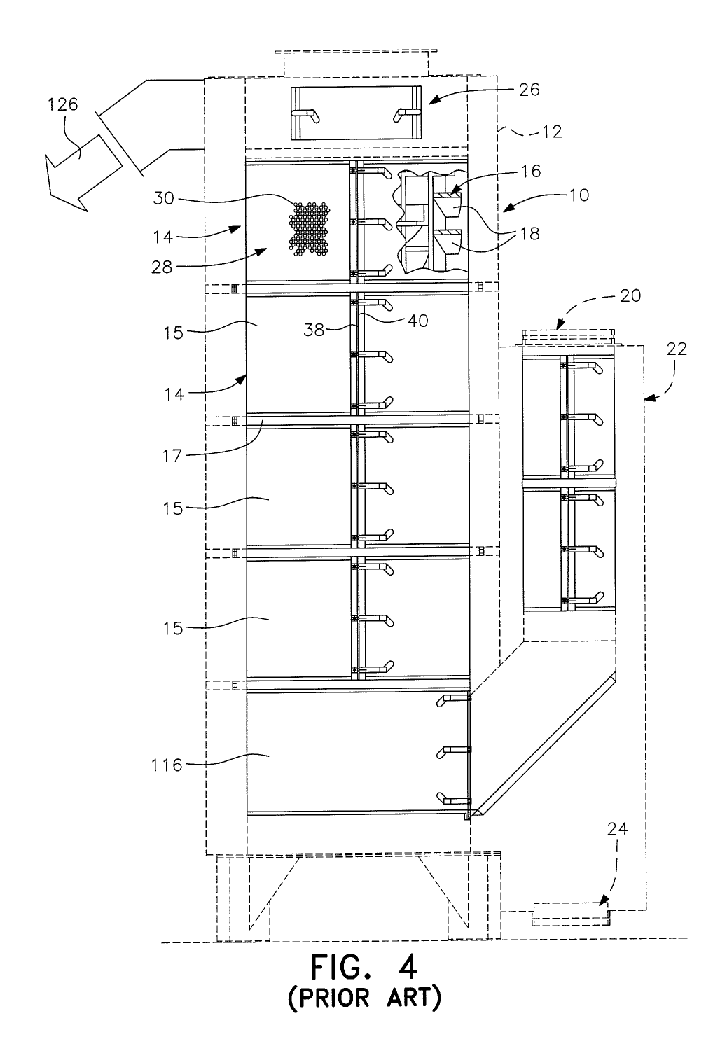

Referring to FIG. 4, a conventional centrifugal pellet dryer of the vertical type is generally designated by reference numeral 10 and includes a dryer housing 12 having a sectional screen 14 mounted vertically therein. The sectional screen 14 is shown having four approximately equal screen sections 15 aligned vertically and interconnected at 17. The screen 14 encloses and is concentric to a bladed rotor, generally designated by reference numeral 16, which includes inclined blades 18. The blades 18 include outer edges adjacent the interior surface of the screen sections 15 supported in a manner well known in the art.

The dryer 10 includes an inlet 20 for receiving a slurry of water and pellets from an underwater pelletizer, or other type water slurry containing solid particles, such as plastic flakes, from recycled soda bottles, milk containers, etc., or other solid plastic particles such as ground battery casings. The inlet 20 typically, although not in all centrifugal dryers, discharges the slurry into a dewaterer 22 for initial separation of water from the pellets or other solid particles for discharge of water through an outlet 24 and discharge of moisture laden particles into the bottom section of the sectional screen 14. The solid particles move upwardly through the screen sections 15 by the action of the rotor 16 to an outlet 26 at the upper end of upper screen section 15 in the direction indicated by the arrow 126. The rotor imparts lift and centrifugal forces to the particles to impact the particles against the screen for separating water from the particles with the separated water passing through the screen into the housing and out through outlet 24 in a manner well known in the art as exemplified by the previously mentioned prior patents.

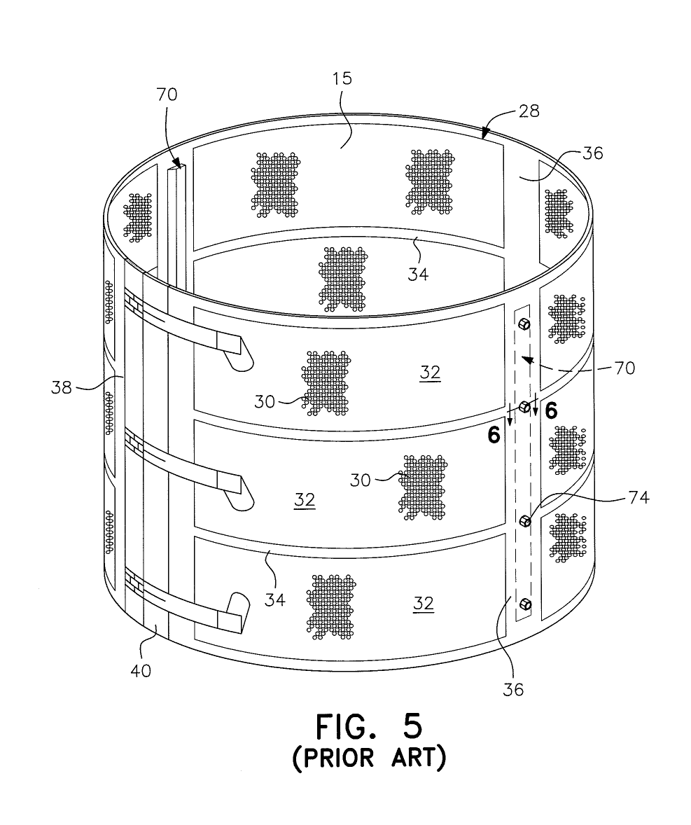

Each of the screen sections 15 includes a plate 28, typically of stainless steel with 20 or 18 gauge thickness and 0.075 inch diameter holes 30 punched therethrough from the surface facing inwardly of screen section 15. Other hole shapes and diameters such as 0.038 inch, 0.085 inch, 0.0625 inch are also commonly used. As shown in FIG. 5, the holes 30 have staggered centers and are oriented in discrete areas 32 thereby defining intersecting solid sections 34 and 36. Each of the screen sections 15 is initially formed as a flat plate 28, which is retained in a cylindrical configuration by connecting outwardly extending vertical side edge flanges 38 and 40 on the respective vertical solid edges the screen section. Further description of the connecting mechanisms is set forth in the '457 patent.

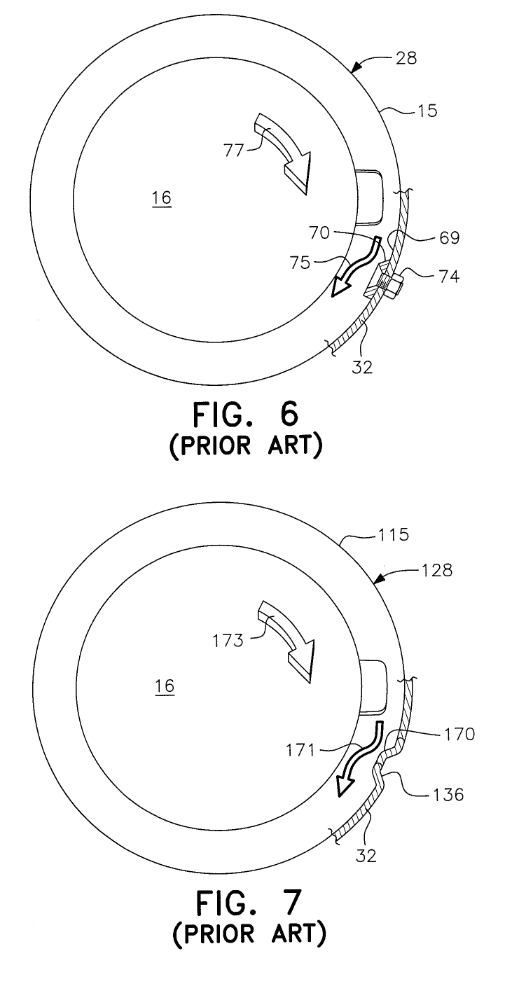

The two deflector strips shown in FIG. 5, and generally designated by reference numeral 70, are mounted on the inside surface of the cylindrical screen section 15. As can be seen in FIGS. 5 and 6, the deflector strips 70 are attached by bolts which protrude through matching holes in the cylindrical screen section 15 on which appropriate locking nuts 74 can be installed to affix each deflector strip 70 in place on the inside of the screen section. Once in place, the deflector strip 70 redirects pellet flow as indicated by the solid arrowed line 75 in FIG. 6, when the rotor 16 turns as indicated by the inner arrow 77.

An integrated embossed inwardly protruding deflector strip as disclosed in the '177 patent is shown in FIG. 7. Like the conventional bolt-on deflector strip in FIG. 6, the embossed deflector strip 170 effectively redirects pellet flow as indicated by the solid arrow 171 when the rotor 16 turns in the direction indicated by the inner arrow 173. Unlike the deflector strip of the '457 patent, however, the embossed deflector strip 70 eliminates the risk of loosened fasteners as well as loose and/or detached deflector strips. The deflector strip 170 does, however, protrude into the area in which the rotor and rotor blades are housed and rotate.

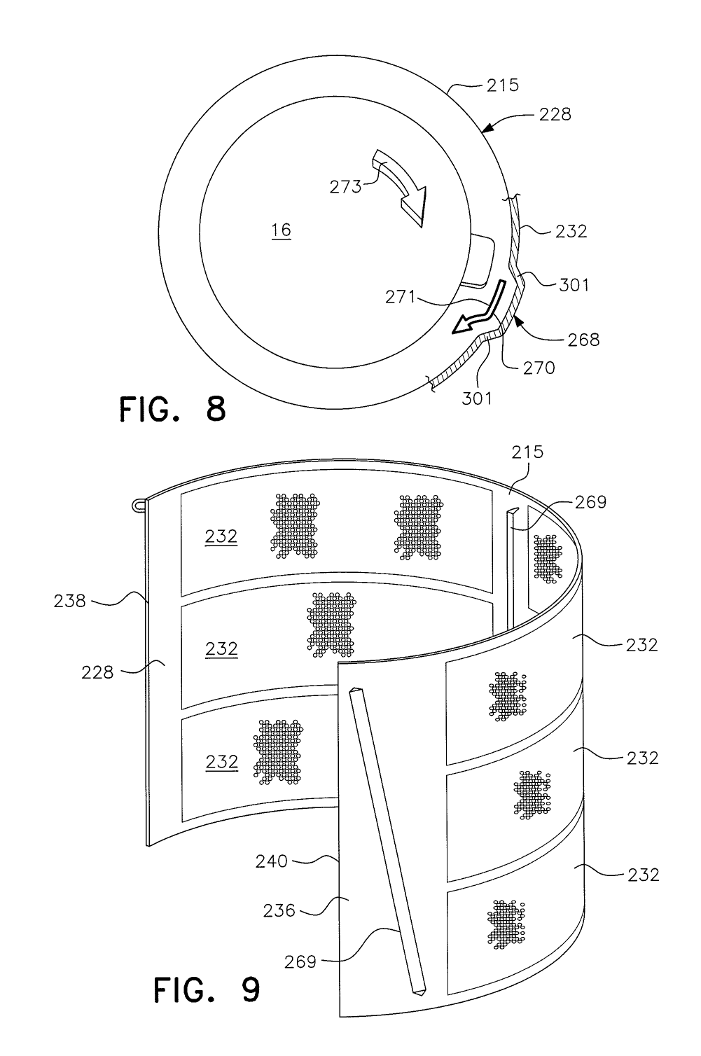

In view of the foregoing, a screen section 215 in accordance with the present invention, shown in FIG. 9, has one or more outwardly projecting embossed regions, generally designated by the reference numeral 268. In the embodiment shown in FIGS. 8-11, the outwardly projecting embossed regions 268 are in the form of elongated vertical or substantially vertical embossed deflector strips 269. The outwardly projecting embossed deflector strips 269 are typically formed integrally into the non-perforated solid sections 228, 236 of the screen that run between the discrete areas 232 having holes therein and adjacent to where the screen edges 238 and 240 come together. The screen section 215 may be provided with only a single embossed deflector strip or multiple embossed deflector strips as is described more fully in the '177 patent.

Alternatively, the embossed outwardly projecting embossed strips 269 could be formed in the perforated areas 232, although this is not preferred as structural strength may be impacted. As a further alternative, if produced at an acutely angled orientation relative to the vertical, the embossed deflector strips may be made to extend across or into portions of both the perforated and non-perforated sections of the screen.

As illustrated in FIG. 8, and like the deflector strip 170 shown in FIG. 7, the embossed region 268 or embossed deflector strip 269 effectively redirects pellet flow as indicated by the solid arrow 271 when the rotor 16 turns in the direction indicated by the inner arrow 273. Unlike the deflector strip of the '177 patent, however, the outwardly projecting embossed region 268 or embossed deflector strip 269 does not impinge upon the space or clearance available inside the screen for rotation of the rotor and rotor blade.

As shown in FIGS. 8 and 10, the outwardly projecting embossed regions 268, whether the regions are embodied in strips 269 or other configurations described below, have a cross-section in a plane perpendicular to the embossed region which is flat along the bottom and with smoothly continuous ramped sides which extend at an obtuse angle to the flat bottom and the adjoining screen wall sections (see FIGS. 8 and 11). This flattened U-shape inherently creates a deflection zone 270 or internal deflecting surface 300 on the inside surface of the embossed region opposite the direction of pellet flow. Preferably, the deflection zone 270 or internal deflecting surface 300 is configured as a smoothly ramped side 301 in the embossed deflection strip 269 or embossed region 268, as shown in FIGS. 8 and 11. The smoothly ramped side 301 offers no opportunity for pellet entrapment between the strip 269 and the screen section 215, thus eliminating the associated risk of contamination in future runs. Particularly when used with flat or lentoid shaped pellets, the smooth continuous ramped side 301 is more effective at ensuring consistent pellet redirection off the deflection zone or surface 300 and into the rotor and blades 18, as shown by arrow 302 (see FIG. 11). Once redirected, the rotor can then impart continual energy to the pellets in the direction indicated by arrow 304, which facilitates their upward movement and overall efficiency of the dryer by decreasing the tendency for the rotor to act as an auger when pellets are the type that resist current methods of centrifugal drying. In addition, the embossed deflector strips actually reduce screen wear in the area of the screen just in front of the embossed strip.

The number, angle and spatial relation of the outwardly projecting embossed regions according to the present invention may vary depending on the diameter of the screen sections 215 and the particular application of the dryer. Usually one to four embossed strips 269 are adequate in most screen sections up to about 64 inches in diameter; greater numbers of embossed strips may, of course, be included as desired. Also in dryers having multiple screen sections 215, the lowest screen section 116 (see FIG. 4), where the water and solid particle slurry enter the screen, may be constructed without embossed regions as the pellets have a lot of energy upon entry from the feed chute. In the upper screen sections having the embossed regions, the regions are preferably aligned vertically, although such alignment is not always necessary.

The outwardly projecting embossed regions or embossed deflector strips in accordance with the present invention can be implemented with conventional unitary screens or screen sections, and made of stainless steel plate, such as plate 228, with 20 or 18 gauge thickness and holes having commonly used diameters of 0.038 inch, 0.075 inch, 0.085 inch, or 0.0625 inch. The screens or screen sections can also be made with lasered holes or by other methods of manufacture as would be understood by persons of ordinary skill in the art. Multi-layered screens such as those set forth in co-pending application, Ser. No. 11/017,216, which is commonly owned by the assignee of this application, can also be modified to include the outwardly projecting embossed regions of the present invention.

While in a preferred embodiment the outwardly projecting embossed regions are preferably vertical or substantially vertical outwardly projecting embossed deflector strips, the strips may be formed at an acute angle relative to the vertical so as to lean away, moving from the bottom of the screen to the top thereof, from the direction of the rotor. Such an angled embossed strip 269, such as illustrated in FIG. 9, may be used to create a more upward trajectory in the movement of the pellets as they impact against and are redirected toward the rotor by the upwardly inclined deflection zone 270 of the embossed strip. Vertical and angled deflector strips may also be combined within the same screen.

The embossed strips 269 of the present invention are typically a flattened U-shape in cross section (as described above and see FIGS. 8 and 11) and project outwardly, relative to the non-embossed outer surface of the screen section 215, by about 0.10 inches to about 0.25 inches, and most preferably about 0.14 inches, and have a width of about 0.25 inches to about 0.80 inches, and most preferably about 0.62 inches. Other dimensions can, of course, be provided and, unlike the mounted deflector strips, do not impact the overall weight of the screen section. For example, in the arrangement of FIGS. 4-6, adding a deflector strip having a larger thickness or larger width will add to the weight of the screen section and place greater demands upon the fastening elements in larger dryer applications. With the outwardly projecting embossed deflector regions of the present invention, however, the dimensions of the embossed strip simply alter the percentage of the solid section 236 that projects outwardly but do not change the overall weight or complexity of the screen section 215.

The length of the outwardly projecting embossed deflector strips 269 depends upon the height of the cylindrical screen section 215, or cylindrical screen if one piece, and are preferably of a length so as to leave a space of about one inch from the top and bottom ends of the deflector strip to the upper and lower edges of the screen section (or screen) so as to not interfere with sealing, although this spacing can be varied as desired.

While the outwardly projecting embossed deflector regions 268 are preferably continuous embossed strips, they could be discontinuous and of smaller length or size so as to facilitate the required wrapping of the screen around the support rings to obtain the cylindrical configuration. Continuous raised strips are preferred because they tend to provide a continuous length of deflection and to offer a great degree of added stiffening to the cylindrical screen or screen section. As such, it is possible that the embossed strips may allow for a thinner screen plate 228.

If the embossed strips 269 are discontinuous, they might preferably be arranged in a vertical staggered array from adjacent the bottom edge of the screen plate 228 to adjacent the top edge of the screen plate 228. In such a manner, banding solid particles which miss one raised strip in a circumferential pass around the clearance band would encounter another raised strip in its path. This staggered arrangement could be similarly embodied with angled embossed deflector strips.

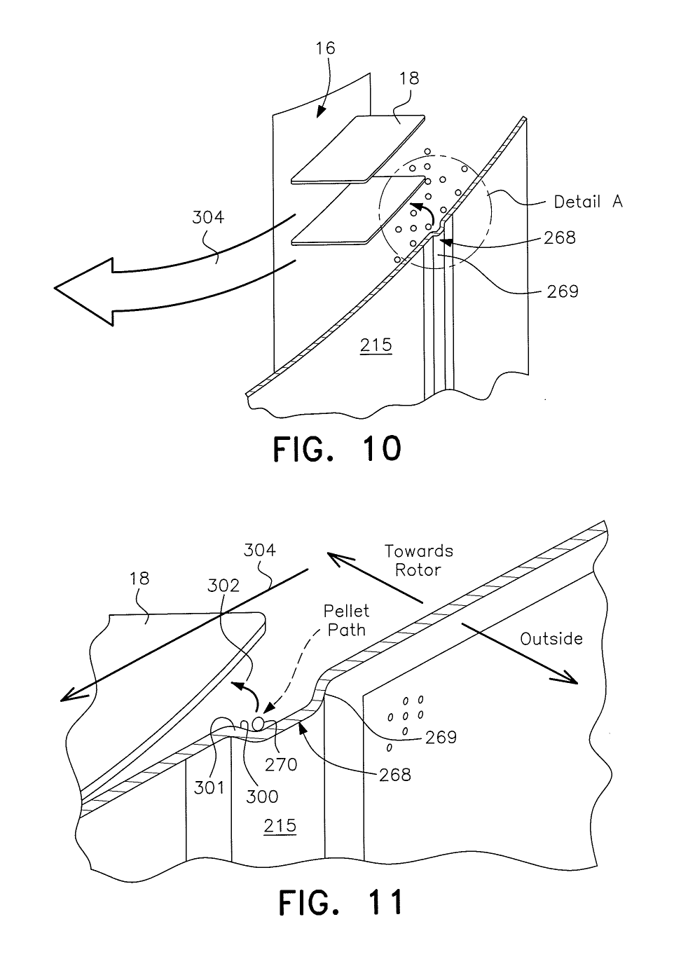

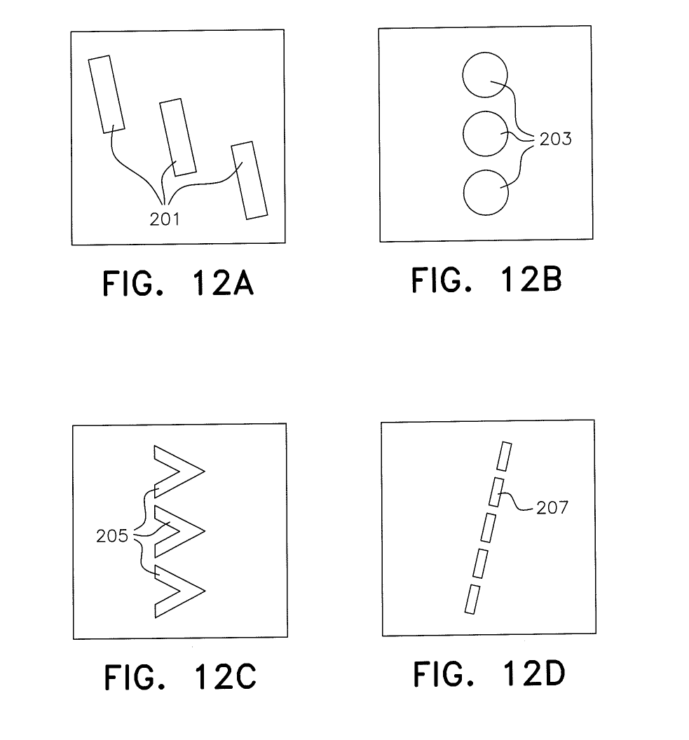

The outwardly projecting embossed regions of the present invention can also be produced in shapes other than elongated strips. Without being limited thereto, examples of alternate configurations for the outwardly projecting embossed regions are shown by the horizontally and vertically staggered rectangles 201 shown in FIG. 12A, the vertically spaced circles 203 shown in FIG. 12B, the vertically spaced arrowheads 205 shown in FIG. 12C and the vertically spaced rectangles 207 in sloped alignment shown in FIG. 12D. In each instance, the cross-section of the outwardly projecting embossed region is preferably the flattened U-shape described previously.

Whatever the specific configuration of the embossed regions, the outwardly projecting embossed deflector screen in accordance with the present invention produces drying results as good as or better than screens having inwardly protruding deflectors. A number of tests were conducted which are summarized in the following Table I. All tests were conducted with a 3032 (auger feed) dryer having a solid rotor turning at 410 RPM (standard speed). The pellets were wetted down in the hopper with ambient temperature water; no additional water was added. The dryer drive was set at 60 Hz, the auger speed was 1750 RPM, the blower was on and the dryer amps were 4.4 with no product running through the dryer. Marflex pellets were used.

TABLE 1
DEFLECTOR SCREEN COMPARISON TESTING

| | | SCREEN | RATE | MOTOR | |
|---|---|---|---|---|---|
| DATE | TIME | TYPE | LBS/HR | AMPS | MOISTURE |
| Feb. 22, 2013 | 1:15 | Standard Screens/No Deflectors | 15,660 | 5.7 | 1.275 |
| Feb. 22, 2013 | 1:30 | | 15,660 | 5.8 | 1.338 |
| Feb. 22, 2013 | 2:15 | Standard Screens/No Deflectors | 15,660 | 5.6 | 1.049 |
| Feb. 21, 2013 | 12:15 | Deflector Screens/Bolt on Deflector | 12,760 | 5.8 | 0.805 |
| Feb. 21, 2013 | 12:45 | | 15,080 | 5.9 | 0.877 |
| Feb. 21, 2013 | 1:15 | Deflector Screens/Bolt on Deflector | 14,500 | 5.9 | 1.060 |
| 2/2213 | 10:40 | Embossed Deflector Screen/Large | 15,660 | 5.5 | 1.116 |
| | | Embossing/Embossing Toward Rotor | | | |
| Feb. 22, 2013 | 10:58 | | 15,660 | 5.6 | 1.084 |
| Feb. 22, 2013 | 11:15 | Embossed Deflector Screen/Large | 15,660 | 5.6 | 1.060 |
| | | Embossing/Embossing Toward Rotor | | | |
| Feb. 22, 2013 | 8:45 | Embossed Deflector Screen/Large | 15,660 | 5.9 | 0.995 |
| | | Embossing/Embossing Toward | | | |
| | | Outside | | | |
| Feb. 22, 2013 | 9:20 | | 16,240 | 5.9 | 1.012 |
| Feb. 22, 2013 | 9:46 | Embossed Deflector Screen/Large | 15,660 | 5.8 | 1.027 |
| | | Embossing/Embossing Toward | | | |
| | | Outside | | | |
| Feb. 21, 2013 | 1:45 | Embossed Deflector Screen/Small | 12,760 | 5.9 | 1.162 |
| | | Embossing/Embossing Toward Rotor | | | |
| Feb. 21, 2013 | 2:15 | | 15,660 | 5.9 | 1.162 |
| Feb. 21, 2013 | 2:30 | Embossed Deflector Screen/Small | 14,500 | 5.8 | 1.141 |
| | | Embossing/Embossing Toward Rotor | | | |
| Feb. 22, 2013 | 7:30 | Embossed Deflector Screen/Small | 15,660 | 5.8 | 1.008 |
| | | Embossing/Embossing Toward | | | |
| | | Outside | | | |
| Feb. 22, 2013 | 7:45 | | 15,660 | 5.8 | 0.855 |
| Feb. 22, 2013 | 7:57 | Embossed Deflector Screen/Small | 16,240 | 5.8 | 0.917 |
| | | Embossing/Embossing Toward | | | |
| | | Outside | | | |

As is evident from the results summarized in Table I, the dryer screen with outwardly projecting embossed deflector strips in accordance with the present invention is just as effective as dryer screens with inwardly projecting deflector strips. Comparable performance as was proven was a result that was surprising to and unexpected by persons of ordinary skill in the art. This outcome was highly beneficial in that, while providing comparable performance to dryer screen configurations with inwardly protruding deflectors which were already known to be effective in pellet drying, the outwardly projecting deflector strips as described herein do not, unlike earlier dryer designs, encroach upon or close in on the clearance of the rotor and rotor blades. Providing the rotor blades with the maximum amount of space provides a significant advantage in that the risk of interference between the rotor blades and the deflector strips is eliminated.

The foregoing is considered as illustrative only of the principles of the invention. Further, since numerous modifications and changes will readily occur to those skilled in the art, it is not desired to limit the invention to the exact construction and operation shown and described, and, accordingly, all suitable modifications and equivalents may be resorted to, falling within the scope of the invention.

What is claimed is:

1. A screen for a centrifugal pellet dryer comprising a substantially cylindrical screen having one or more integrally formed embossed regions which project outwardly from an outer surface of the screen, each embossed region forming a deflection zone that disrupts a circular flow of particles being dried to improve particle flow through a rotor area of the dryer.

2. The screen as set forth in claim 1, wherein each embossed region forms a generally vertical embossed deflector strip.

3. The screen as set forth in claim 1, wherein said screen includes a plurality of embossed regions formed as substantially vertical embossed deflector strips spaced from one another around the circumference of the screen.

4. The screen as set forth in claim 3, wherein said strips are arranged in a staggered array from adjacent a bottom edge of the screen to adjacent a top edge of the screen.

5. The screen as set forth in claim 1, wherein said screen includes perforated and non-perforated areas, said embossed regions being integrally formed in said non-perforated areas.

6. The screen as set forth in claim 1, wherein each embossed region forms an embossed deflector strip having a smoothly continuous flattened U-shape.

7. The screen as set forth in claim 2, wherein said embossed deflector project outwardly, relative to non-embossed portions of said outer surface, about 0.10 inches to about 0.25 inches.

8. The screen as set forth in claim 7, wherein said outwardly projecting embossed deflector strips have a width of about 0.25 inches to about 0.80 inches.

9. The screen as set forth in claim 2, wherein said embossed deflector strips project outwardly, relative to non-embossed portions of said outer surface, about 0.14 inches and have a width of about 0.62 inches.

10. The screen as set forth in claim 1, wherein said outwardly projecting embossed regions extend substantially from a top of the screen to a bottom thereof.

11. A centrifugal pellet dryer comprising a dryer housing having a cylindrical screen mounted vertically therein, generally concentric with a bladed rotor, an inlet for receiving a slurry of water and solid particles into a bottom section of the screen, said solid particles being moved upwardly in a circular flow through the screen by the rotor to an outlet at an upper end of the screen, said screen having at least one integral embossed region that projects outwardly from an outer surface of the screen to form an internal deflecting surface which disrupts the circular flow of particles being dried to improve particle flow through the dryer.

12. The dryer as set forth in claim 11, wherein each outwardly projecting embossed region forms a substantially vertical embossed deflector strip.

13. The dryer as set forth in claim 11, wherein said screen includes a plurality of outwardly projecting embossed regions formed as substantially vertical embossed deflector strips spaced from one another around the circumference of the screen.

14. The dryer as set forth in claim 13, wherein said outwardly projecting deflector strips are arranged in a staggered array from adjacent a bottom edge of the screen to adjacent a top edge thereof.

15. The dryer as set forth in claim 12, wherein said screen includes perforated and non-perforated areas, each said outwardly projecting deflector strip being integrally formed in a non-perforated area.

16. The dryer as set forth in claim 12, wherein said screen includes perforated and non-perforated areas, said outwardly projecting deflector strip being formed at least partially in a perforated area.

17. The dryer as set forth in claim 11, wherein each outwardly projecting embossed region has a cross-section with a flat bottom and smoothly continuous ramped sides.

18. The dryer as set forth in claim 13, wherein said outwardly projecting embossed deflector strips have a width of from about 0.25 inches to about 0.80 inches and project outwardly, relative to non-embossed portions of said outer surface, about 0.10 inches to about 0.25 inches.

19. The dryer as set forth in claim 11, wherein said outwardly projecting embossed deflector strips have a width of about 0.62 inches and project outwardly, relative to non-embossed portions of said outer surface, about 0.14 inches.
